(19) United States
(12) Patent Application Publication
(10) Pub. No.: US 2024/0044931 A1
(43) Pub. Date: Feb. 8, 2024

(54) BIOLOGICAL ANALYZER SYSTEM INCLUDING A PUMP

(71) Applicant: BECKMAN COULTER, INC., Brea, CA (US)

(72) Inventor: Jozef SOFKA, Redwood City, CA (US)

(21) Appl. No.: 18/231,355

(22) Filed: Aug. 8, 2023

Related U.S. Application Data
(60) Provisional application No. 63/395,913, filed on Aug. 8, 2022.

(51) Int. Cl. G01N 35/10; F04B 43/12

(52) U.S. Cl. CPC G01N 35/1095; F04B 43/12

(57) ABSTRACT

A biological analyzer system includes a biological analyzer, a fluid routing system, and a first linear peristaltic pump. The biological analyzer is configured to analyze a biological sample. The fluid routing system is configured to direct the biological sample into the biological analyzer. The first linear peristaltic pump is configured to move the biological sample in the fluid routing system. The first linear peristaltic pump includes a first hollow flexible tubing, a first actuation assembly, and a first tubing compression member. The first hollow flexible tubing extends along a first longitudinal axis. The first hollow flexible tubing is in fluid communication with the fluid routing system. The first tubing compression member is configured to move relative to the first hollow flexible tubing along a predetermined path in response to an input from the first actuation assembly to advance fluid within the first hollow flexible tubing along the first longitudinal axis.

### PRIORITY

This application claims the filing benefit of U.S. Pat. App. No. 63/395,913, entitled Unidirectional Linear Peristaltic Pump,” filed Aug. 8, 2022, the disclosure of which is incorporated by reference herein.

### BACKGROUND

Fluidic systems utilize a source of positive or negative pressure to move liquids, which may generally be obtained pneumatically or through the use of liquid pumps. Different pumps may be utilized to fulfill different design requirements. One such pump, a rotary peristaltic pump, is disclosed in U.S. Pat. No. 7,150,607, entitled “Uniform Flow Displacement Pump,” issued Dec. 19, 2006, the disclosure of which is incorporated by reference herein. This rotary peristaltic pump rotates one or more rollers to pinch a flexible tubing at pinch points, and advance the pinch points along the tubing length in the direction of the intended flow. The flexible tubing follows a circular path, enabling convenient pinching action via rotary movement of an arm connecting a pinching roller to a centrally located gear motor. Continuous motor movement in the same direction provides unidirectional flow. Unfortunately, the size and shape of the rotary peristaltic pump does not allow for compact arrangement for small spaces. Accordingly, there is a need for improvements in the art related to pumps, more specifically peristaltic pumps, having a more streamlined form factor with at least equivalent performance.

To sufficiently compress flexible tubing, a high compression force is applied. In some systems, the use of multiple peristaltic pumps undesirably increases the overall dimensions of the system. Accordingly, there is a need for improvements in the art related to peristaltic pumps having a more streamlined form factor with at least equivalent performance to allow for a more efficient spatial arrangement of instrument components leading to a significant reduction in overall system size.

### SUMMARY

A biological analyzer system includes a biological analyzer, a fluid routing system, and a first linear peristaltic pump. The biological analyzer is configured to analyze a biological sample. The fluid routing system is configured to direct the biological sample into the biological analyzer. The first linear peristaltic pump is configured to move the biological sample in the fluid routing system. The first linear peristaltic pump includes a first hollow flexible tubing , a first actuation assembly, and a first tubing compression member. The first hollow flexible tubing extends along a first longitudinal axis. The first hollow flexible tubing is in fluid communication with the fluid routing system. The first tubing compression member is configured to move relative to the first hollow flexible tubing along a predetermined path in response to an input from the first actuation assembly to advance fluid within the first hollow flexible tubing along the first longitudinal axis.

A biological analyzer system includes a biological analyzer, a fluid routing system, and a linear peristaltic pump. The biological analyzer configured to analyze a biological sample. The fluid routing system is configured to direct the biological sample into the biological analyzer. The linear peristaltic pump is configured to move the biological sample in the fluid routing system through the biological analyzer. The linear peristaltic pump includes a base, a cam operatively coupled with the base, an actuation assembly, a hollow flexible tubing at least partially supported by the base, and a tubing compression assembly. The tubing compression assembly includes first and second ends. The first end is configured to move relative to the actuation assembly in response to an input from the actuation assembly. The second end is disposed opposite the first end and is configured to move along the cam in response to movement of the first end.

A linear peristaltic pump includes a base, a cam, an actuation assembly, hollow flexible tubing, and a tubing compression assembly. The cam is operatively coupled with the base. The hollow flexible tubing is at least partially supported by the base. The hollow flexible tubing includes a lumen configured to move fluid therethrough. The hollow flexible tubing extends along a longitudinal axis. The tubing compression assembly includes a first end, a second end, and a tubing compression member. The first end is configured to move relative to the actuation assembly in response to an input from the actuation assembly. The second end is configured to move along the cam in response to movement of the first end. The tubing compression member is configured to move relative to the hollow flexible tubing along a predetermined path to advance fluid linearly within the hollow flexible tubing along the longitudinal axis in response to movement of the second end.

### BRIEF DESCRIPTION OF THE DRAWINGS

FIG. 1 is a schematic illustration, partly in section and not to scale, showing operational aspects of an exemplary flow cell and high optical resolution imaging device for sample image analysis using digital image processing.

FIG. 2 depicts a perspective view of an example of a linear peristaltic pump with a cover removed to expose a tubing compression assembly that moves relative to a hollow flexible tubing;

FIG. 3A depicts a side elevational view of the linear peristaltic pump of FIG. 2, with the tubing compression assembly disposed at a first position to partially compress the hollow flexible tubing;

FIG. 3B depicts a side elevational view of the linear peristaltic pump of FIG. 3A, but with the tubing compression assembly moved to a second position during a drive stroke to compress the hollow flexible tubing between the cam and the base;

FIG. 3C depicts a side elevational view of the linear peristaltic pump of FIG. 3B, but with the tubing compression assembly moved to a third position to partially compress the hollow flexible tubing between the cam and the base;

FIG. 3D depicts a side elevational view of the linear peristaltic pump of FIG. 3C, but with the tubing compression assembly moved to a fourth position during a return stroke;

FIG. 4A depicts an enlarged side elevational view of a portion of FIG. 3D, but with the tubing compression assembly moved to a fifth position during the return stroke;

FIG. 4B depicts an enlarged side elevational view similar to FIG. 4A, but with the tubing compression assembly moved to a sixth position during the return stroke;

FIG. 4C depicts an enlarged side elevational view similar to FIG. 4B, but with the tubing compression assembly moved to the first position of FIG. 3A;

FIG. 5 depicts a front view of another example of a linear peristaltic pump that includes first and second cams that interact with first and second followers;

FIG. 6 depicts a side elevational view of another example of a linear peristaltic pump that includes a motor positioned in a second arrangement;

FIG. 7 depicts a rear view of the linear peristaltic pump of FIG. 6;

FIG. 8 depicts a perspective view of a linear peristaltic pump assembly that includes a plurality of linear peristaltic pumps of FIG. 2 positioned adjacent a rotary peristaltic pump assembly that includes a plurality rotary peristaltic pumps positioned in a first arrangement;

FIG. 9 depicts a front view of the linear peristaltic pump assembly and the rotary peristaltic pump assembly of FIG. 8;

FIG. 10 depicts a top view of the linear peristaltic pump assembly and the rotary peristaltic pump assembly of FIG. 8;

FIG. 11 depicts a front view of the linear peristaltic pump assembly of FIG. 8 positioned adjacent a rotary peristaltic pump assembly that includes a plurality of rotary peristaltic pumps of FIG. 8 positioned in a second orientation;

FIG. 12 depicts a top view of the linear peristaltic pump assembly and the rotary peristaltic pump assembly of FIG. 11;

FIG. 13A schematically depicts a first example of a biological analyzer system; and

FIG. 13B schematically depicts a second example of a biological analyzer system.

### DETAILED DESCRIPTION

The identification of various types of particles in a blood sample, or a urine sample is an exemplary application for which the subject matter is particularly well suited, though other types of body fluid samples may be used. For example, aspects of the disclosed technology may be used in analysis of a non-blood body fluid sample comprising blood cells (e.g., white blood cells and/or red blood cells), such as serum, bone marrow, lavage fluid, effusions, exudates, cerebrospinal fluid, pleural fluid, peritoneal fluid, and amniotic fluid. It is also possible that the sample can be a solid tissue sample, e.g., a biopsy sample that has been treated to produce a cell suspension. The sample may also be a suspension obtained from treating a fecal sample. A sample may also be a laboratory or production line sample comprising particles, such as a cell culture sample. The term sample may be used to refer to a sample obtained from a patient or laboratory or any fraction, portion or aliquot thereof. The sample can be diluted, divided into portions, or stained in some processes.

In some aspects, samples are presented, imaged and analyzed in an automated manner. In the case of blood samples, the sample may be substantially diluted with a suitable diluent or saline solution, which reduces the extent to which the view of some cells might be hidden by other cells in an undiluted or less-diluted sample. The cells can be treated with agents that enhance the contrast of some cell aspects, for example using permeabilizing agents to render cell membranes permeable, and histological stains to adhere in and to reveal features, such as granules and the nucleus. In some cases, it may be desirable to stain an aliquot of the sample for counting and characterizing particles which include reticulocytes, nucleated red blood cells, and platelets, and for white blood cell differential, characterization and analysis. In other cases, samples containing red blood cells may be diluted before introduction to the flow cell and/or imaging in the flow cell or otherwise. In the case of urine samples, the number of agents or reagents used may be more limited—for instance, a staining agent may not be necessary since the different cellular materials in urine are more easily discernable than in blood.

The particulars of sample preparation apparatus and methods for sample dilution, permeabilizing and histological staining, generally may be accomplished using precision pumps and valves operated by one or more programmable controllers. Examples can be found in patents such as U.S. Pat. No. 7,319,907. Likewise, techniques for distinguishing among certain cell categories and/or subcategories by their attributes such as relative size and color can be found in U.S. Pat. No. 5,436,978 in connection with white blood cells. The disclosures of these patents are hereby incorporated by reference in their entirety.
A. Overview of Flow Cell and Imaging

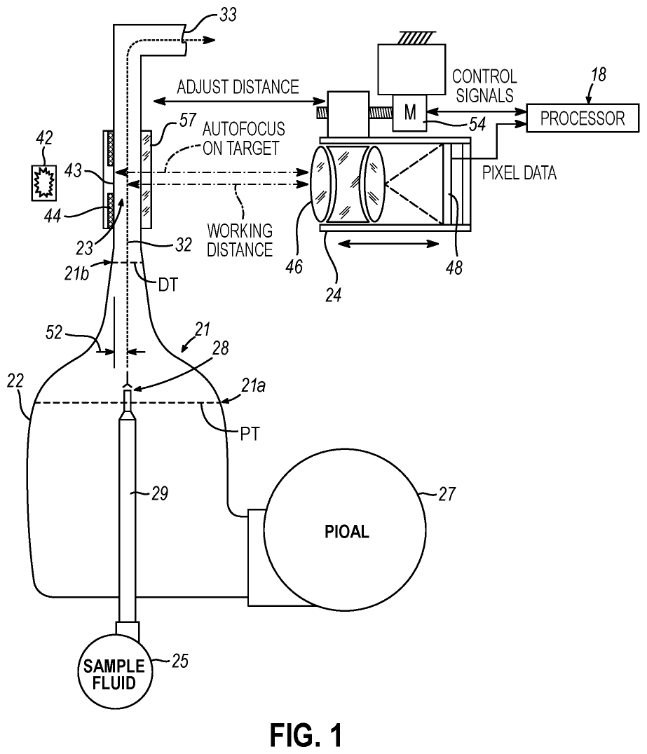

Turning now to the drawings, FIG. 1 schematically shows an exemplary flow cell (22) for conveying a sample fluid through a viewing zone (23) of a high optical resolution imaging device (24) in a configuration for imaging microscopic particles in a sample flow stream (32) using digital image processing. Flow cell (22) is coupled to a source (25) of sample fluid which may have been subjected to processing, such as contact with a particle contrast agent composition and heating. Flow cell (22) is also coupled to one or more sources (27) of a sheath fluid, in some examples the sheath fluid is a particle and/or intracellular organelle alignment liquid (PIOAL), such as a clear glycerol solution having a viscosity that is greater than the viscosity of the sample fluid. Though the term sheath and PIAOL may be used herein, they should be treated as similar, in that they are used to surround a sample fluid during the image capture/visualization process.

The sample fluid is injected through a flattened opening at a distal end (28) of a sample feed tube (29), and into the interior of the flow cell (22) at a point where the PIOAL flow has been substantially established resulting in a stable and symmetric laminar flow of the PIOAL above and below (or on opposing sides of) the ribbon-shaped sample stream. The sample and PIOAL streams may be supplied by precision metering pumps that move the PIOAL with the injected sample fluid along a flowpath that narrows substantially. The PIOAL envelopes and compresses the sample fluid in the zone (21) where the flowpath narrows. Hence, the decrease in flowpath thickness at zone (21) can contribute to a geometric focusing of the sample stream (32). The sample fluid ribbon (32) is enveloped and carried along with the PIOAL downstream of the narrowing zone (21), passing in front of, or otherwise through the viewing zone (23) of, the high optical resolution imaging device (24) where images are collected, for example, using a CCD (48). In this way, flow imaging is performed where images from the flowing sample stream and the cellular material contained therein are collected. Processor (18) can receive, as input, pixel data from CCD (48). The sample fluid ribbon flows together with the PIOAL to a discharge (33).

As shown here, the narrowing zone (21) can have a proximal flowpath portion (21a) having a proximal thickness (PT) and a distal flowpath portion (21b) having a distal thickness (DT), such that distal thickness (DT) is less than proximal thickness (PT). The sample fluid can therefore be injected through the distal end (28) of sample tube (29) at a location that is distal to the proximal portion (21a) and proximal to the distal portion (21b). Hence, the sample fluid can enter the PIOAL envelope as the PIOAL stream is compressed by the zone (21). Wherein the sample fluid injection tube has a distal exit port through which sample fluid is injected into flowing sheath fluid, the distal exit port bounded by the decrease in flowpath size of the flow cell.

The digital high optical resolution imaging device (24) with objective lens (46) is directed along an optical axis that intersects the ribbon-shaped sample stream (32). The relative distance between the objective lens (46) and the flow cell (22) is variable by operation of a motor drive (54), for resolving and collecting a focused digitized image on a photosensor array. The imaging device (24) is focused on an autofocus pattern (44) fixed relative to a flowcell (22), wherein the autofocus pattern (44) is located at a displacement distance (52) from a ribbon-shaped sample stream (32). The flowcell (22) is configured to direct a flow (32) of the sample enveloped with the PIOAL through a viewing zone (23) in the flowcell, namely behind viewing port (57). Light from a light source (42) may illuminate sample particles flowing within the flow stream (32). Additional information regarding the construction and operation of an exemplary flow cell such as shown in FIG. 1 is provided in U.S. Pat. No. 9,322,752, entitled “Flow Cell Systems and Methods for Particle Analysis in Blood Samples,” filed on Mar. 17, 2014, the disclosure of which is hereby incorporated by reference in its entirety.

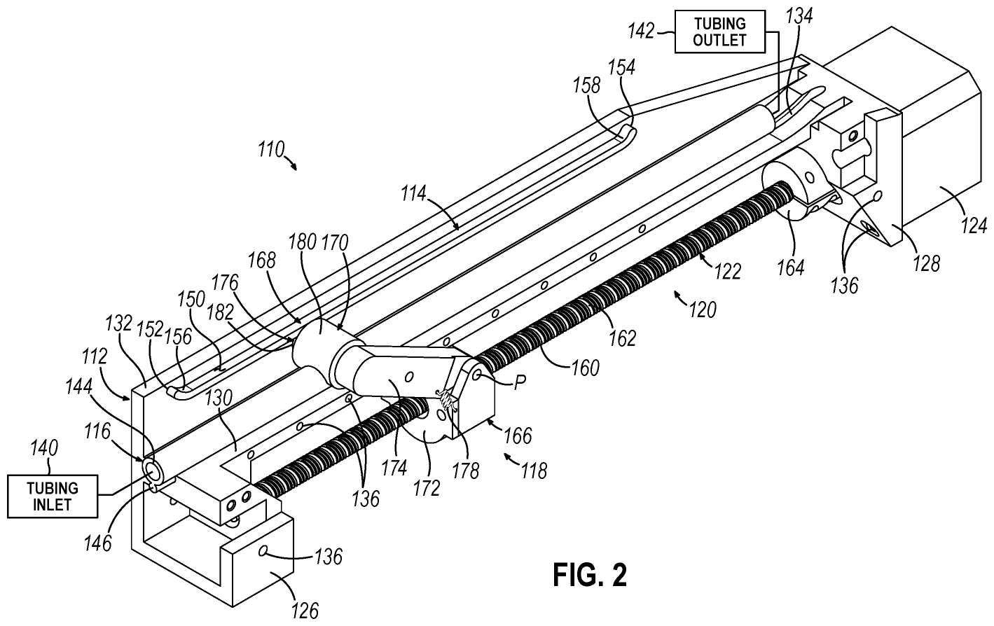

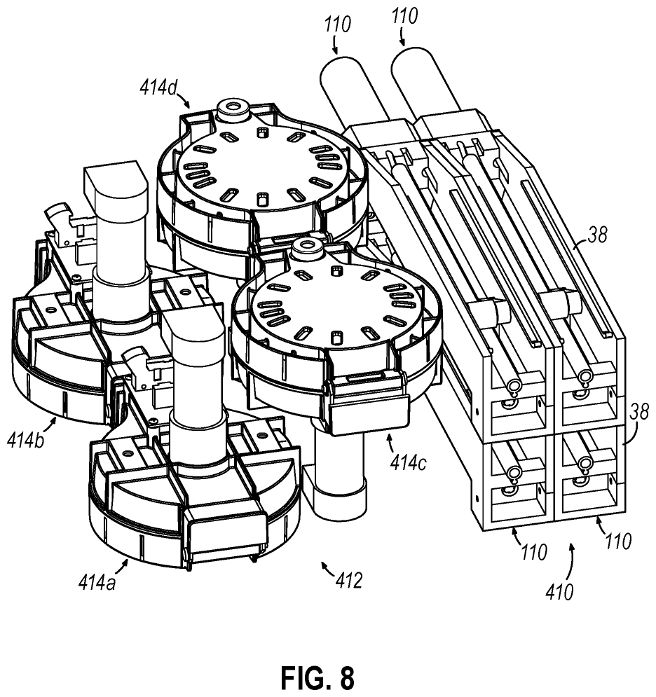

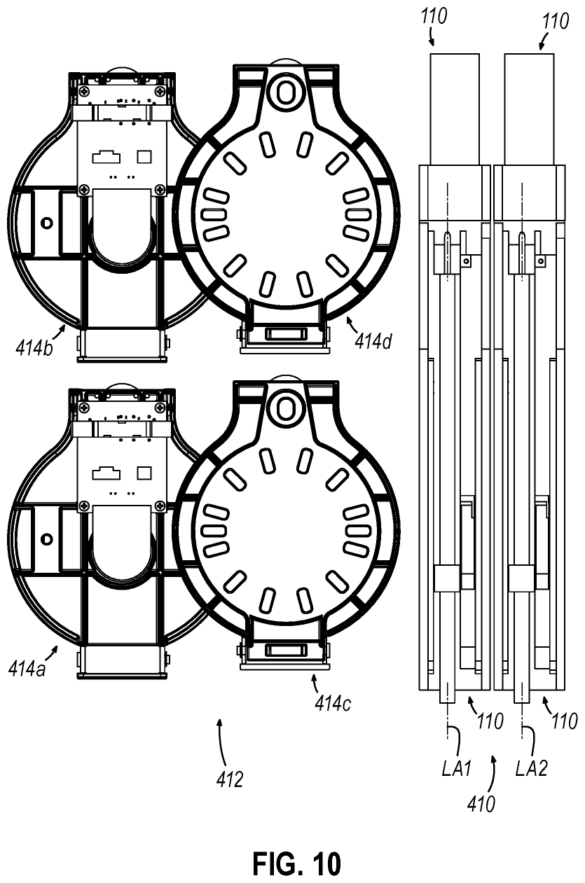

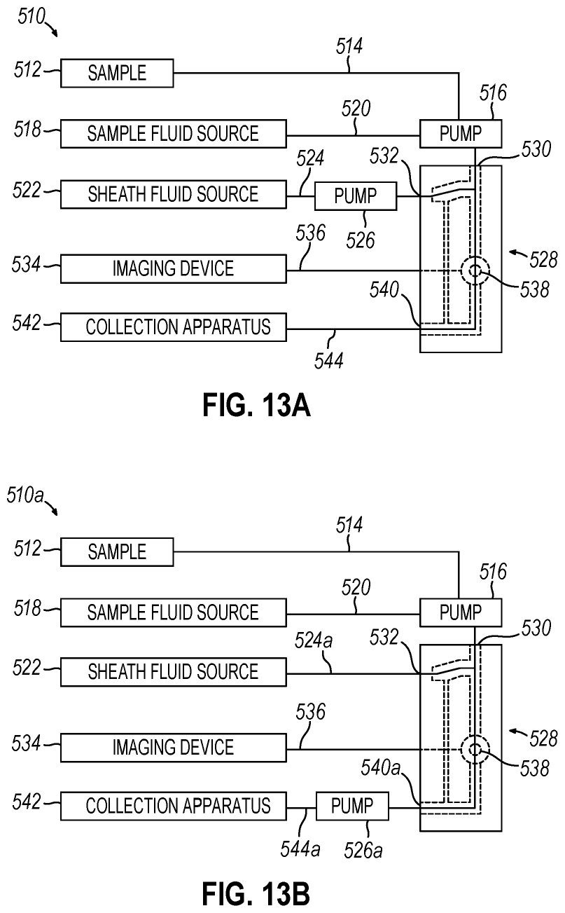

The present disclosure relates to apparatus, systems, compositions, and methods for moving fluid. Various exemplary linear peristaltic pumps (110, 210, 310) will be described in greater detail with reference to FIGS. 2-7. The linear peristaltic pumps (110, 210, 310) may be combined with other linear peristaltic pumps (110, 210, 310) to form a linear peristaltic pump assembly (410), which will be described in greater detail with reference to FIGS. 8-12. The linear peristaltic pumps (110, 210, 310) may be used in the biological analyzer systems (510, 510a), which will be described in greater detail with reference to FIGS. 13A-13B.
B. First Example of a Linear Peristaltic Pump

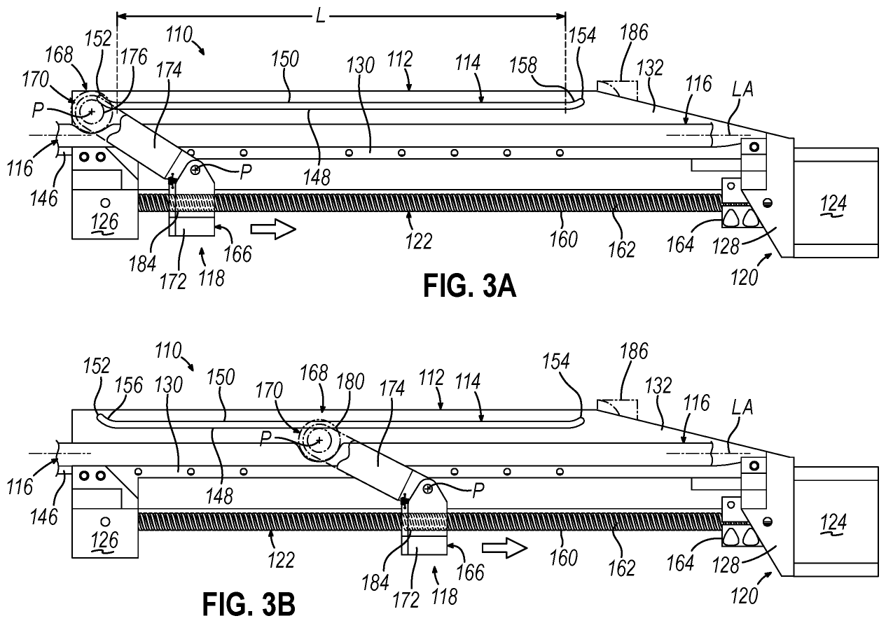

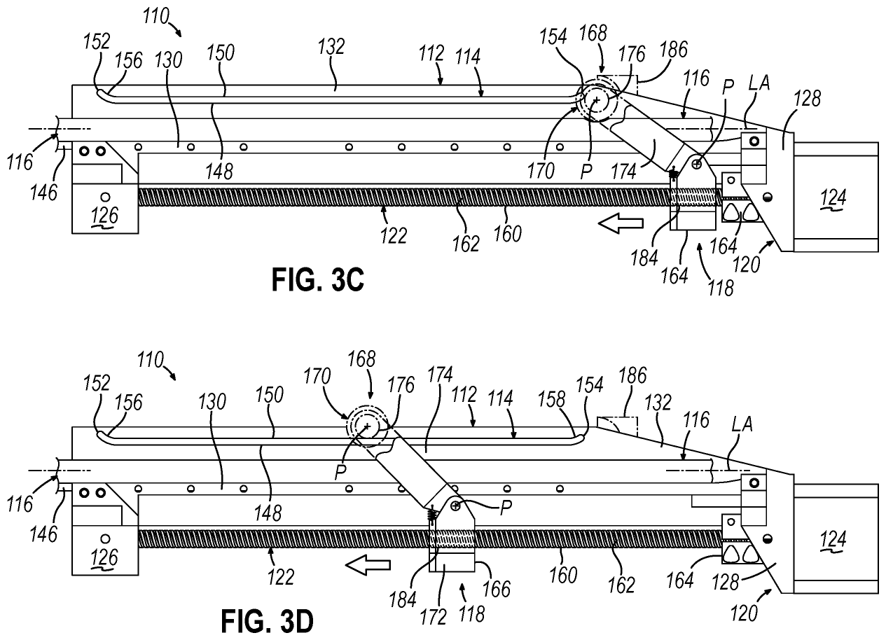

FIGS. 2-4C show a first example of a linear peristaltic pump (110). As shown, the linear peristaltic pump (110) includes a base (112), a cam (114), a length of hollow flexible tubing (116), a tubing compression assembly (118), and an actuation assembly (120). The actuation assembly (120) depicted in FIGS. 2-3D includes a rail (122) and a motor (124).

The base (112) extends along a longitudinal direction. As shown, the base (112) includes

opposing first and second legs (126, 128) that support a platform (130) and a wall (132). While wall (132) is shown as being vertical, other orientations of wall are also envisioned. The platform (130) includes an engagement feature (134) to engage and retain the hollow flexible tubing (116). The base (112) may be integrally formed together as a unitary piece or include a plurality of individual components that are coupled together. As shown, the base (112) includes apertures (136) configured to receive fasteners (not shown). A cover (138), shown in FIG. 8, is removed in FIGS. 2-4C to expose the tubing compression assembly (118) that moves relative to the hollow flexible tubing (116).

The hollow flexible tubing (116) extends along a longitudinal axis (LA) between a tubing inlet (140) and a tubing outlet (142), which are shown schematically in FIG. 2. The hollow flexible tubing (116) is shown as being linear. The hollow flexible tubing (116) includes a lumen (144) configured to move fluid (e.g., incompressible liquid) therethrough. The hollow flexible tubing (116) is at least partially supported by the platform (130) of the base (112). As shown in FIG. 2, the hollow flexible tubing (116) includes an engagement feature (146) configured to selectively attach with the engagement feature (134) of the platform (130) of the base (112). The hollow flexible tubing (116) may be formed of any suitable flexible material.

The cam (114) is operatively coupled with the wall (132) of the base (112). In some versions, the cam (114) may be integrally formed together as a unitary piece together with the base (112). The cam (114) includes opposing first and second contact surfaces. As shown, the first contact surface includes a lower surface (148) of the cam (114) and the second contact surface includes an upper surface (150) of the cam (114). The cam (114) includes first and second terminal ends (152, 154). The first terminal end (152) is positioned upstream and closer to the tubing inlet (140) than the second terminal end (154) which is disposed closer to the tubing outlet (142). Except for the first and second terminal ends (152, 154), the cam (114) extends linearly along an axis parallel to the longitudinal axis (LA) of the hollow flexible tubing (116). At least one of the first and second terminal ends (152, 154) may include an arcuate portion that extends in a direction away from the hollow flexible tubing (116). As shown, the first terminal end (152) includes a first arcuate portion (156) and the second terminal end (154) includes a second arcuate portion (158) (shown in phantom). The first and second arcuate portions (156, 158) function as ramps to allow unidirectional flow operation moving from a left-to-right direction or unidirectional flow operation moving from a right-to-left direction. As shown in FIGS. 2-3D, the actuation assembly (120) includes the rail (122), the motor (124), and a motor screw coupler (164). The rail (122) extends along at least a portion of the base (112). The rail (122) extends linearly along an axis parallel to the longitudinal axis (LA) of the hollow flexible tubing (116). As shown, the rail (122) includes a drive screw (160) with helical threading (162). One such suitable rail (122) is a Dryspin® drive screw commercially available from Igus® of Rumford, Rhode Island. The drive screw (160) is rotationally coupled with an output of the motor (124) using the motor screw coupler (164). In some versions, the rail (122) may include a linear guide rail or a rack of a rack and pinion assembly that receives an input from motor (124). Alternatively, the actuation assembly (120) may be belt driven using a belt (not shown).

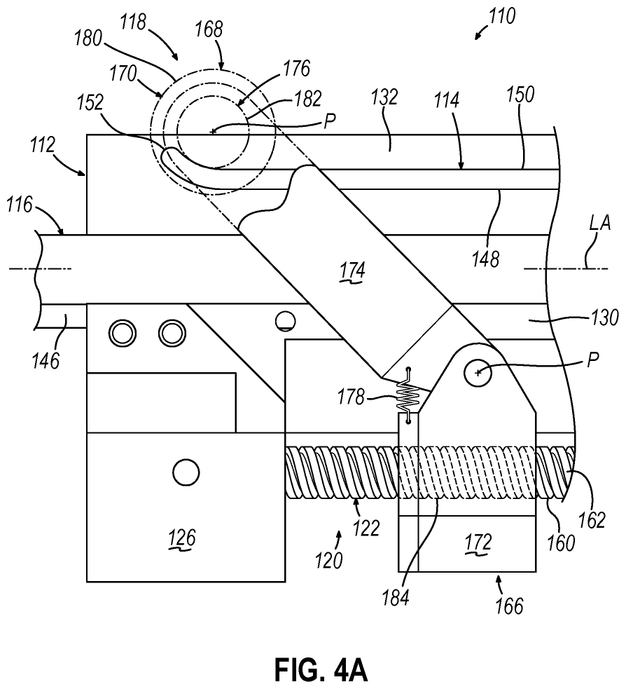

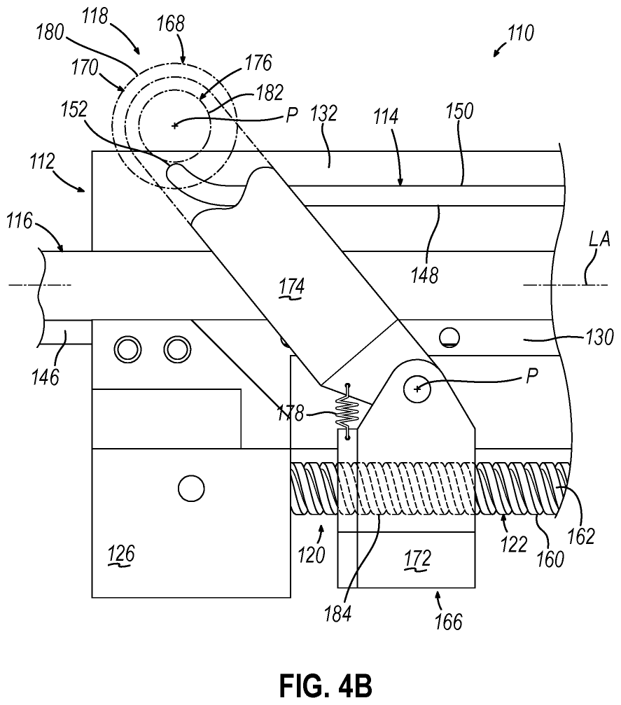

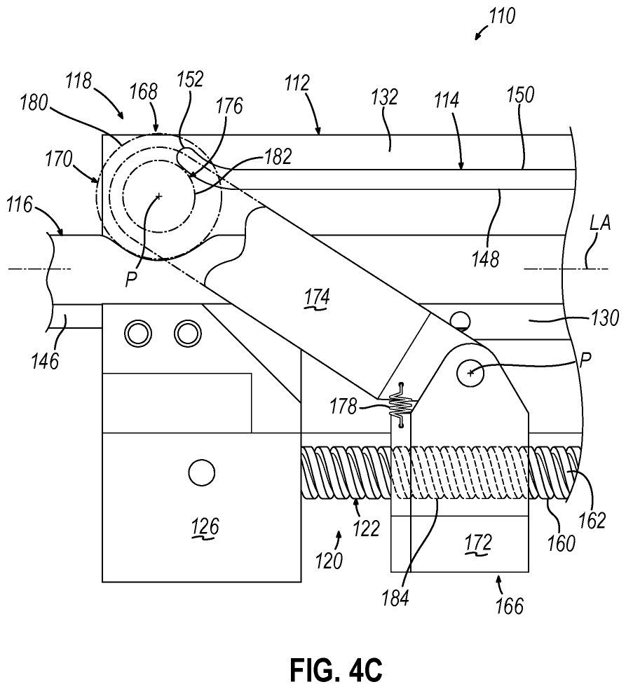

As shown in FIG. 2, the tubing compression assembly (118) includes a first end (166), a second end (168), a tubing compression member (170) a carriage (172), a connecting arm (174), a follower (176), and an optional biasing member (178) (see FIGS. 2 and 4A-4C). The first end (166) of the tubing compression assembly (118) is configured to move using the rail (122) in response to the input from the motor (124) that is transmitted using the rail (122). The second end (168) of the tubing compression assembly (118) is configured to move along the cam (114) in response to movement of the first end (166) of the tubing compression assembly (118). The carriage (172) is disposed at the first end (166) of the tubing compression assembly (118). The carriage (172) may move along the drive screw (160) in response to the input provided from the motor (124).

The connecting arm (174) couples the follower (176) and the tubing compression member (170) with the carriage (172). The connecting arm (174) is pivotably coupled with the carriage (172). The connection between a roller (180) and the carriage (172) is facilitated by the connecting arm (174) with pivot points (P) at ends of the connecting arm (174). For example, as shown in a comparison between FIG. 3C and FIG. 3D, the second end (168) may pivot relative to the first end (166) at a pivot point (P). In some versions, the carriage (172) includes a linear bearing carriage configured to move along the linear rail. The follower (176) is disposed at the second end (168) of the tubing compression assembly (118). The follower (176) includes a bearing (182) that is configured to move along the lower surface (148) and the upper surface (150) of the cam (114) in response to movement of the carriage (172). The optional biasing member (178) (see FIGS. 4A-4C) biases the follower (176) into abutting engagement with the cam (114).

The tubing compression member (170) is configured to move relative to the hollow flexible tubing (116) and the rail (122) along the predetermined path to advance the incompressible liquid contained within the hollow flexible tubing (116) from the tubing inlet (140) to the tubing outlet (142) in response to movement of the second end (168). The carriage (172), disposed at the first end (166) of the tubing compression assembly (118), includes threading (184) that is configured to engage the threading (162) of the rail (122) as the first end (166) moves relative to the rail (122). The tubing compression member (170) includes the roller (180) configured to move relative to the hollow flexible tubing (116). While FIGS. 3A-4C show the roller (180) as being coaxially aligned with the follower (176) to decouple the amount of compression from the connecting arm angle; in other versions, roller (180) may be non-coaxially aligned with the follower (176). Particularly, the roller (180) is configured to move relative to the hollow flexible tubing (116) and the rail (122) along the predetermined path to advance fluid within the hollow flexible tubing (116) in response to movement of the follower (176) along the cam (114).

The operation of the linear peristaltic pump (110) is shown and described with reference to FIGS. 3A-4C. Actuation of the linear peristaltic pump (110) follows a predetermined path that includes a drive stroke and a return stroke. During the drive stroke, the second end (168) contacts the lower surface (148) of the cam (114) and the hollow flexible tubing (116) to move the fluid within the lumen (144) of the hollow flexible tubing (116). During the return stroke, the second end (168) contacts the upper surface (150) of the cam (114) without contacting the hollow flexible tubing (116). The follower (176) may be in continuous contact with the cam (114) using the biasing member (178) through the return stroke. During the drive stroke, the tubing compression member (170) compresses hollow flexible tubing (116). Conversely, during the return stroke, the tubing compression member (170) does not compress the hollow flexible tubing (116).

In operation, the output of the motor (124) rotates the drive screw (160) causing the carriage (172) to translate along the drive screw (160). The translation of the carriage (172) moves the tubing compression member (170) along the cam (114) to compress the hollow flexible tubing (116). This compression of the hollow flexible tubing (116) moves the fluid contained within the hollow flexible tubing (116). For example, when the rail (122) includes a drive screw (160), the first end (166) of the tubing compression member (170) moves along the drive screw (160) in response to the input.

As shown in FIG. 3A, the predetermined path may begin with the carriage (172) pulling the roller (180) toward the second terminal end (154) of the cam (114) (to the right) while the arcuate portion (156) functions as a ramp at the first terminal end (152) of the cam (114) to push the roller (180) toward the hollow flexible tubing (116) causing the roller (180) to pinch the hollow flexible tubing (116). As shown in a comparison between FIG. 3A and FIG. 3B, as the carriage (172) continues to pull the roller (180) to the right, the advancing pinch in the hollow flexible tubing (116) causes the incompressible liquid contained within the lumen (144) of the hollow flexible tubing (116) to move to the right (i.e., downstream), until the roller (180) reaches the second terminal end (154) of the cam (114).

As shown in FIG. 3C, at the second terminal end (154) of the cam (114), the roller (180) is pushed upward due to the force exerted by the hollow flexible tubing (116) since there is no longer a downward force exerted by the cam (114) at the position shown in FIG. 3C. In some versions, the second terminal end (154) may include an arcuate portion (158) (see FIG. 2) to assist in bidirectional flow. Alternatively or in addition to arcuate portion (158), the base (112) may include an optional guide (186) shown schematically in phantom in FIGS. 3A-3D that projects out from the base (112). The guide (186) may be coupled with the wall (132) of the base (112). The guide (186) may be positioned above the cam (114) constraining the otherwise unrestricted angular motion of the connecting arm (174) when the roller (180) is above the cam (114). The guide (186) is spaced a distance from the cam (114) and is configured to contact the follower (176) to direct the follower (176) between the drive and return strokes. This distance accommodates the diameter of the follower (176). As shown in a comparison between FIG. 3C and FIG. 3D, the movement of the carriage (172) is then reversed in the return stroke, and the roller (180) is pushed back to the first terminal end (152) of the cam (114) while moving along the upper surface (150) of the cam (114).

In FIG. 4B, the biasing member (178) (shown as a spring) is in an extended state, while in FIG. 4C the biasing member (178) is in a retracted state. With the motion of the roller (180) limited to the length of the cam (114), bidirectional flow may be achieved. For instance, in some embodiments, alternating flow direction may be obtained when the hollow flexible tubing (116) remains pinched with location of the roller (180) constrained along a length (L) of FIG. 3A. This may be useful, for example, in cases where an intermittent direction reversal is desired for the practical operation of the fluidic circuit. Thus, in some applications, both a pushing and a pulling action may be usefully provided utilizing the same pump.

As shown in a comparison between FIG. 4B and FIG. 4C, after the roller (180) reaches the first terminal end (152) of the cam (114), the roller (180) drops on to the hollow flexible tubing (116) due to gravity or spring loading due to biasing member (178) and the cycle repeats along the predetermined path as shown in FIGS. 3A-4B.
C. Second Example of a Linear Peristaltic Pump

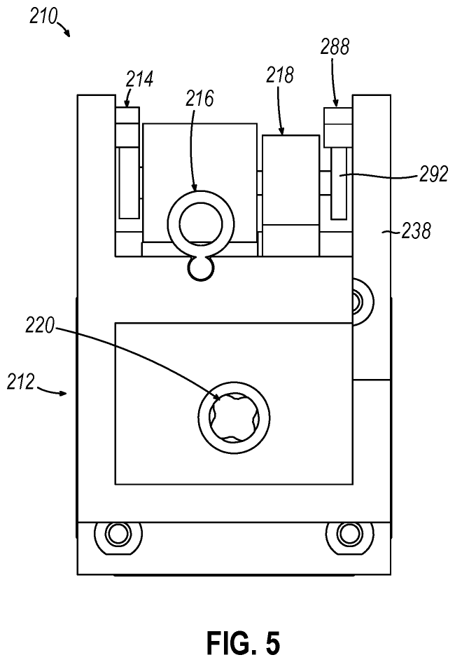

FIG. 5 depicts a second exemplary linear peristaltic pump (210). Linear peristaltic pump (210) is similar to linear peristaltic pump (110) described above with reference to FIGS. 2-4C, unless otherwise described below. Similar to linear peristaltic pump (110), the linear peristaltic pump (210) includes a base (212), a cam (214), a length of hollow flexible tubing (216), a tubing compression assembly (218), an actuation assembly (220), and a cover (238).

Unlike the linear peristaltic pump (110) described above, the linear peristaltic pump (210) includes a second cam (288) disposed on the cover (238) that has a similar profile to cam (114) described above. In this version, the tubing compression assembly (218) includes a second follower (292) that interacts with the second cam (288) of the cover (238) between the drive and return strokes. The second cam (288) provides additional structural support to reduce moment forces that are otherwise created with the interaction of the cam (214) and the tubing compression assembly (218).
D. Third Example of a Linear Peristaltic Pump

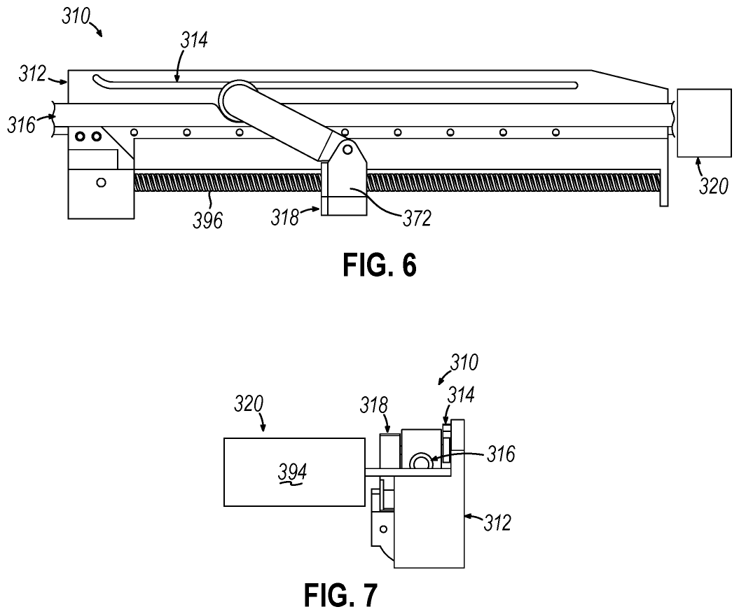

FIGS. 6-7 depict a third exemplary linear peristaltic pump (310). Linear peristaltic pump (310) is similar to linear peristaltic pump (110) described above with reference to FIGS. 2-4C, unless otherwise described below. Similar to the linear peristaltic pump (110), the linear peristaltic pump (310) includes a base (312), a cam (314), a length of hollow flexible tubing (316), a tubing compression assembly (318), and an actuation assembly (320).

The linear peristaltic pump (310) that includes a motor (394) positioned in a different orientation than motor (124) described above. Particularly, the motor (394) is oriented with its axis perpendicular to the motion of the carriage (372). This configuration may incorporate a rack-and-pinion assembly or a belt (396) (shown schematically) instead of the rail (122) (e.g., drive screw (160)) described above with reference to the linear peristaltic pump (110).
E. Exemplary Linear Pump Assembly

Medical devices may utilize one or more linear peristaltic pumps (110, 210, 310). For example, the iQ200 Series Urine Microscopy Analyzer, commercially available from Beckman Coulter Inc. of Brea, California includes three peristaltic pumps. Examples of medical devices are disclosed in U.S. Pat. No. 6,825,926, entitled “Flow Cell for Urinalysis Diagnostic System and Method of Making Same,” issued November 30, 2004; U.S. Pat. No. 6,947,586, entitled “Multi-Neural Net Imaging Apparatus and Method,” issued Sep. 20, 2005; U.S. Pat. No. 7,236,623, entitled “Analyte Recognition for Urinalysis Diagnostic System,” issued Jun. 26, 2007; U.S. Pat. No. 8,391,608, entitled “Method and Apparatus for Analyzing Body Fluids,” issued Mar. 5, 2013; U.S. Pat. No. 7,324,694, entitled “Fluid Sample Analysis Using Class Weights,” issued Jan. 29, 2008; U.S. Pat. No. 7,702,172, entitled “Particle Extraction for Automatic Flow Microscope,” issued Apr. 20, 2010. The disclosure of each of the above-cited U.S. patents is incorporated by reference herein in its entirety. For example, first and second linear peristaltic pumps (110, 210, 310) may be included to obtain a desired flow, and a third linear peristaltic pump (110, 210, 310) may be included for cleaning. The linear peristaltic pumps (110, 210, 310) facilitate stable flow for precise hydrodynamic focusing and the flow-through nature for waste evacuation. Use of multiple peristaltic pumps further enhances the benefits associated with the linear peristaltic pumps (110, 210, 310).

FIGS. 8-10 show a linear peristaltic pump assembly (410) that includes four linear peristaltic pumps (110) positioned adjacent a rotary peristaltic pump assembly (22412) that includes 4 rotary peristaltic pumps (414a-d) positioned in a first arrangement. While FIGS. 8-10 are shown with reference to the linear peristaltic pumps (110), the general principles also apply to linear peristaltic pumps (210, 310). In the first arrangement, two rotary peristaltic pumps (414a-b) are in a first orientation and two rotary peristaltic pumps (414c-d) are in a second orientation (rotated 180 degrees). The linear peristaltic pump assembly (410) allows for stacking of the linear peristaltic pumps (110) in a compact arrangement. The linear peristaltic pumps (110) may be operatively coupled with each other to produce a compact and stable arrangement. For example, the linear peristaltic pumps (110) may be coupled together using fasteners (not shown). As shown, two linear peristaltic pumps (110) extend along a first longitudinal axis (LA1), two linear peristaltic pumps (110) extend along a second longitudinal axis (LA2). The first longitudinal axis (LA1) extends parallel to the second longitudinal axis (LA2).

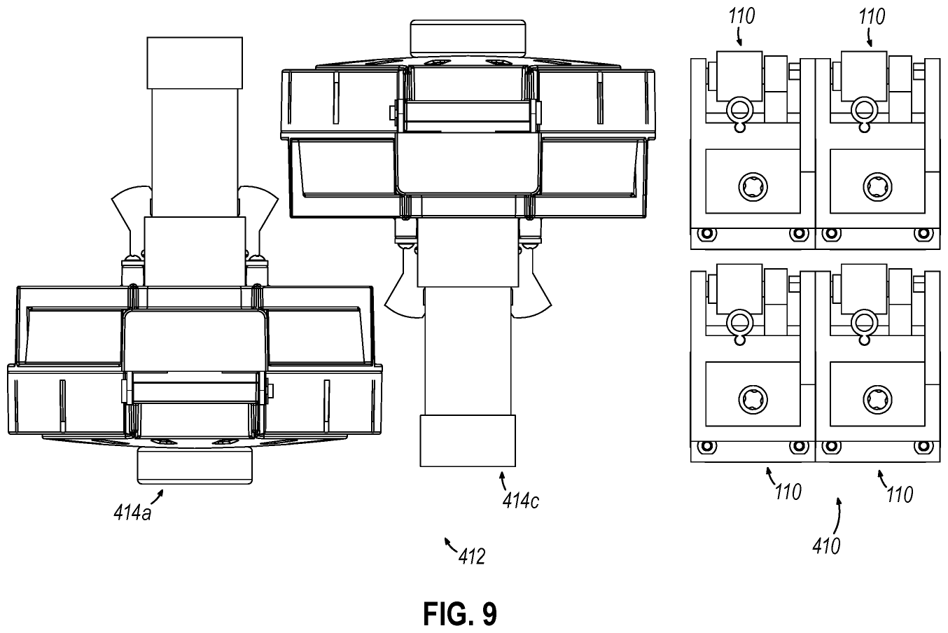

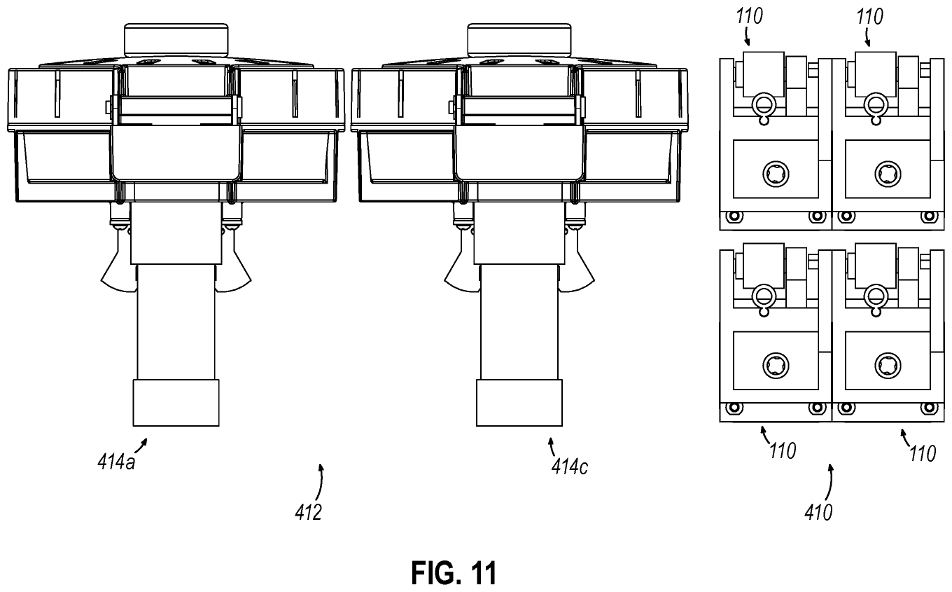

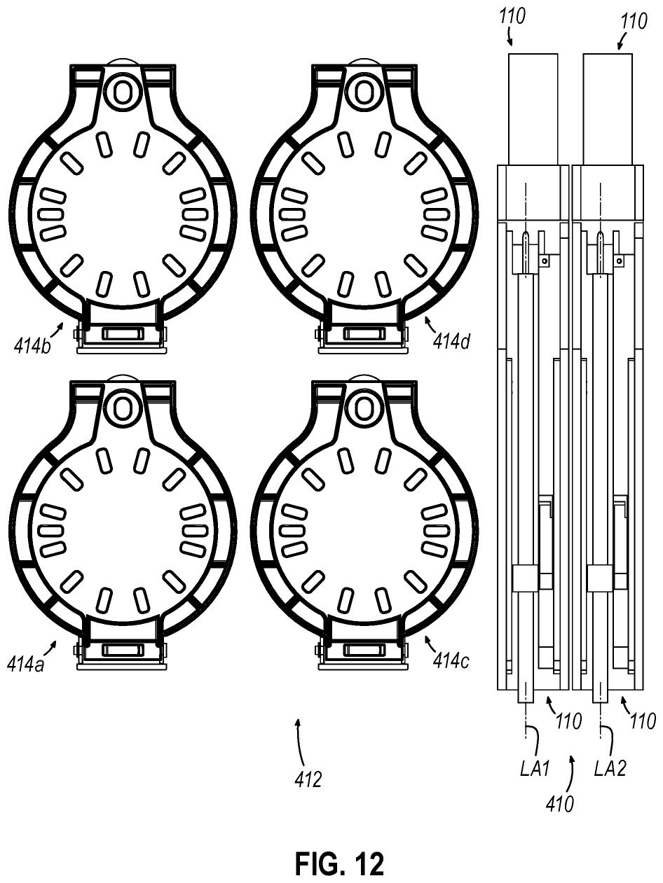

FIGS. 11-12 show the linear peristaltic pump assembly (410) similar to FIG. 9 that includes four linear peristaltic pumps (110) positioned adjacent a rotary peristaltic pump assembly (416) that includes 4 rotary peristaltic pumps (418a-d) of FIG. 8 positioned in a second arrangement. In the second arrangement, each of the rotary peristaltic pumps (418a-d) are in the first orientation producing a less efficient arrangement than the rotary peristaltic pump assembly (412) of FIGS. 8-10.
F. First Example of a Biological Analyzer System

FIG. 13A schematically shows a first example of a biological analyzer system (510). The biological analyzer system (510) includes a biological sample (512) in fluid communication with a pump (516) using tubing (514). As described above, the sample may include a blood sample, a urine sample, a non-blood body fluid sample, a solid tissue sample, a suspension obtained from treating a fecal sample, and/or a laboratory or production line sample comprising particles. The pump (516) is in fluid communication with a sample fluid source (518) containing sample fluid. The sample fluid source (518) transfers the sample fluid using tubing (520) to the pump (516). The pump (516) is configured to push the sample fluid and the biological sample (512) into a biological analyzer (528). The pump (516) may include a linear peristaltic pump (110, 210, 310) or a rotary peristaltic pump (418a-d). For example, linear peristaltic pumps (110, 210, 310) are configured to move the biological sample (512) and the sample fluid through the biological analyzer (528). For example, the inlet (140) of the linear peristaltic pump (110) may be in fluid communication with the tubing (514, 520), and the tubing outlet (142) of the linear peristaltic pump (110) may be in fluid communication with the first inlet (530) of the biological analyzer (528) or tubing to connect the two. As shown, the pump (516) is positioned upstream of the biological analyzer (528).

With continued reference to FIG. 13A, a sheath fluid source (522) contains sheath fluid. The sample fluid and the sheath fluid may have the same or different fluid composition. In some instances, the sample fluid and sheath fluid may be contained in a single reservoir. The sheath fluid from the sheath fluid source (522) is transferred using tubing (524) to pump (526). Pump (526) is positioned upstream of the biological analyzer (528) and is configured to push the sheath fluid into the biological analyzer (528). Similar to pump (516), pump (526) may include a linear peristaltic pump (110, 210, 310) or a rotary peristaltic pump (418a-d). For example, the tubing inlet (140) of the linear peristaltic pump (110) may be in fluid communication with tubing (524), and the tubing outlet (142) of the linear peristaltic pump (110) may be in fluid communication with the second inlet (532) of the biological analyzer (528) or tubing to connect the two. The hollow flexible tubing of the pump (526) may have an inner diameter that is greater than the inner diameter of the hollow flexible tubing of pump (516). Similarly, the tubing (524) may have an inner diameter that is greater than the inner diameter of the tubing (520). Tubing (514, 520, 524) may be collectively referred to as a fluid routing system that is configured to direct the biological sample (512), the sample fluid, and the sheath fluid into the biological analyzer (528). The fluid routing system includes a plurality of tubing segments (e.g., tubing (514, 520, 524)) in fluid communication with the biological analyzer (528). The biological sample (512), the sample fluid source (518), and the sheath fluid source (522) are in fluid communication with the fluid routing system.

The biological analyzer (528) is configured to analyze the biological sample (512). While the biological analyzer is shown as a flow cell, a variety of other suitable biological analyzers are also envisioned. The pump (516) transfers (e.g., pushes) the biological sample (512) and sample fluid from the sample fluid source (518) to a first inlet (530) of the biological analyzer (528). Similarly, the pump (526) transfers (e.g., pushes) the sheath fluid from the sheath fluid source (522) into a second inlet (532) of the biological analyzer (528). In this manner, the biological analyzer system (510) may be considered a push-push system as the pumps (516, 526) each push the respective fluid into and through the biological analyzer (528). Within at least an analysis region (538) of the biological analyzer (528), the sheath fluid generally surrounds the sample fluid and the biological sample (512) as the biological sample (512) is being analyzed. As shown, an imaging device (534) may be used to capture image(s) (536) of the biological sample (512) within the analysis region (538). The sample fluid, the biological sample (512), and the sheath fluid exit the biological analyzer (528) at an outlet (540), and travel through tubing (544) into a collection apparatus (542). While not shown, the biological analyzer system (510) may include one or more valves (e.g., three-way valves), debubbling equipment, filters, and/or other equipment.
G. Second Example of Biological Analyzer System

FIG. 13B schematically shows a second example of a biological analyzer system (510a). Similar to biological analyzer system (510), the biological analyzer system (510a) includes the biological sample (512), the tubing (514), the pump (516), the sample fluid source (518) containing the sample fluid, the tubing (520), the sheath fluid source (522) containing the sheath fluid, the biological analyzer (528) including first and second inlets (530, 532), the imaging device (534), and the collection apparatus (542). Similar to biological analyzer system (510), the pump (516) may include a linear peristaltic pump (110, 210, 310) or a rotary peristaltic pump (418a-d). The tubing (514, 520, 524a) may be collectively referred to as a fluid routing system that is configured to direct the biological sample (512), sample fluid, and sheath fluid into the biological analyzer (528). The tubing (514a) extends between the sheath fluid source (522) and the second inlet (532).

Unlike FIG. 13A where the pump (526) transfers (e.g., pushes) sheath fluid from the sheath fluid source (522) into the second inlet (532) of the biological analyzer (528), the biological analyzer system (510a) of FIG. 13B does not have a pump positioned between the sheath fluid source (522) and the biological analyzer (528). Instead, a pump (526a) is positioned between the outlet (540a) of the biological analyzer (528) and the collection apparatus (542). The pump (526a) is positioned downstream of the biological analyzer (528) and is configured to pull the biological sample (512) through the biological analyzer (528). In this manner, the biological analyzer system (510a) may be considered a push-pull system. Particularly, pump (516) pushes the biological sample (512) and the sample fluid into the biological analyzer (528), and pump (526a) pulls the fluid through the biological analyzer (528). Pump (526a) may include a linear peristaltic pump (110, 210, 310) or a rotary peristaltic pump (418a-d). For example, the tubing inlet (140) of the linear peristaltic pump (110) may be in fluid communication with the outlet (542a) of the biological analyzer (528) or tubing to connect the two, and the tubing outlet (142) of the linear peristaltic pump (110) may be in fluid communication with tubing (544a). The pumps (516, 526a) may be synchronized. The pump (526a) may be referred to as an evacuation pump.

The sample fluid, the biological sample (512), and the sheath fluid exit the biological analyzer (528) at an outlet (540a), and travel through tubing (544a) into a collection apparatus (542). Similar to biological analyzer system (510), the biological analyzer system (510a) may include one or more valves (e.g., three-way valves), debubbling equipment, filters, and/or other equipment. Biological analyzer systems (510, 510a) may include additional aspects as shown and described in U.S. Prov. Pat. App. No. 63/294,648 entitled “Biological Sample Driving System and Method,” filed on Dec. 29, 2021, the disclosure of which is incorporated by reference herein, in its entirety.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the present invention is not limited to the embodiments described above or depicted in the drawings, and various embodiments and modifications can be made without departing from the scope of the claims below.

I/we claim:

1. A biological analyzer system comprising:
(a) a biological analyzer configured to analyze a biological sample;
(b) a fluid routing system configured to direct the biological sample into the biological analyzer; and
(c) a first linear peristaltic pump configured to move the biological sample in the fluid routing system through the biological analyzer, the first linear peristaltic pump comprising:
a first hollow flexible tubing extending along a first longitudinal axis, wherein the first hollow flexible tubing is in fluid communication with the fluid routing system,
(ii) a first actuation assembly, and
(iii) a first tubing compression member configured to move relative to the first hollow flexible tubing along a predetermined path in response to an input from the first actuation assembly to advance fluid within the first hollow flexible tubing along the first longitudinal axis.

2. The biological analyzer system of claim 1, wherein the first linear peristaltic pump is positioned upstream of the biological analyzer and is configured to push the biological sample through the biological analyzer.

3. The biological analyzer system of claim 1, wherein the first linear peristaltic pump is positioned downstream of the biological analyzer and is configured to pull the biological sample through the biological analyzer.

4. The biological analyzer system of claim 1, further comprising a sample fluid source containing sample fluid, wherein the sample fluid source is in fluid communication with the fluid routing system, wherein the first linear peristaltic pump is configured to push the sample fluid and the biological sample into the biological analyzer.

5. The biological analyzer system of claim 1, further comprising a sheath fluid source containing sheath fluid, wherein the sheath fluid source is in fluid communication with the fluid routing system, wherein the sheath fluid is configured to generally surround the biological sample while traveling through at least a portion of the biological analyzer.

6. The biological analyzer system of claim 5, further comprising a second linear peristaltic pump positioned upstream of the biological analyzer and configured to push the sheath fluid into the biological analyzer.

7. The biological analyzer system of claim 6, the second linear peristaltic pump comprising:
(i) second hollow flexible tubing extending along a second longitudinal axis, wherein the second hollow flexible tubing is in fluid communication with the fluid routing system,
(ii) a second actuation assembly, and
(iii) a second tubing compression member configured to move relative to the second hollow flexible tubing along a predetermined path in response to an input from the second actuation assembly to advance the sheath fluid within the second hollow flexible tubing along the second longitudinal axis.

8. The biological analyzer system of claim 7, wherein the first hollow flexible tubing has a first inner diameter, wherein the second hollow flexible tubing has a second inner diameter that is greater than the first inner diameter.

9. The biological analyzer system of claim 1, wherein the fluid routing system includes a plurality of tubing segments in fluid communication with the biological analyzer.

10. The biological analyzer system of claim 1, wherein the biological analyzer includes a flow cell.

11. The biological analyzer system of claim 1, wherein the biological analyzer includes an analysis region, the biological analyzer system further comprising an imaging device configured to capture at least one image of the biological sample within the analysis region.

12. The biological analyzer system of claim 1, the first linear peristaltic pump further comprising:
(i) a base, and
(ii) a cam operatively coupled with the base, wherein the first hollow flexible tubing is at least partially supported by the base.

13. The biological analyzer system of claim 12, the first linear peristaltic pump further comprising a tubing compression assembly, the tubing compression assembly comprising:
(A) a first end configured to move relative to the first actuation assembly in response to an input from the first actuation assembly, and
(B) a second end configured to move along the cam in response to movement of the first end.

14. The biological analyzer system of claim 13, the tubing compression assembly comprising the first tubing compression member, wherein the first tubing compression member is configured to move relative to the hollow flexible tubing along the predetermined path in response to an input from the first actuation assembly to advance fluid linearly within the first hollow flexible tubing along the first longitudinal axis in response to movement of the second end.

15. A biological analyzer system comprising:
(a) a biological analyzer configured to analyze a biological sample;
(b) a fluid routing system configured to direct the biological sample into the biological analyzer; and
(c) a linear peristaltic pump configured to move the biological sample in the fluid routing system through the biological analyzer, the linear peristaltic pump comprising:
(i) a base,
(ii) a cam operatively coupled with the base,
(iii) an actuation assembly,
(iv) a hollow flexible tubing at least partially supported by the base, and
(v) a tubing compression assembly comprising:
(A) a first end configured to move relative to the actuation assembly in response to an input from the actuation assembly, and
(B) a second end disposed opposite the first end and configured to move along the cam in response to movement of the first end.

16. The biological analyzer system of claim 15, wherein the hollow flexible tubing extends along a longitudinal axis, the tubing compression assembly further comprising a tubing compression member configured to move relative to the hollow flexible tubing along a predetermined path to advance fluid linearly within the hollow flexible tubing along the longitudinal axis in response to movement of the second end.

17. The biological analyzer system of claim 16, wherein the tubing compression assembly further comprises:
(i) a carriage disposed at the first end and configured to move along the actuation assembly, and
(ii) a follower disposed at the second end and configured to move along the cam.

18. The biological analyzer system of claim 17, wherein the tubing compression assembly further comprises a connecting arm coupling the follower and the tubing compression member with the carriage, wherein the connecting arm is pivotably coupled with the carriage.

19. The biological analyzer system of claim 17, wherein the first linear peristaltic pump further comprises a guide spaced a distance from the cam and configured to contact the follower to direct the follower along a portion of the predetermined path.

20. A linear peristaltic pump comprising:
(a) a base;
(b) a cam operatively coupled with the base;
(c) an actuation assembly;
(d) hollow flexible tubing at least partially supported by the base, wherein the hollow flexible tubing includes a lumen configured to move fluid therethrough, wherein the hollow flexible tubing extends along a longitudinal axis; and
(e) a tubing compression assembly comprising:
(i) a first end configured to move relative to the actuation assembly in response to an input from the actuation assembly,
(ii) a second end configured to move along the cam in response to movement of the first end, and
(iii) a tubing compression member configured to move relative to the hollow flexible tubing along a predetermined path to advance fluid linearly within the hollow flexible tubing along the longitudinal axis in response to movement of the second end.
